(19) United States
(12) Patent Application Publication
(10) Pub. No.: US 2024/0256883 A1
(43) Pub. Date: Aug. 1, 2024

(54) REINFORCEMENT LEARNING USING QUANTILE CREDIT ASSIGNMENT

(71) Applicant: DeepMind Technologies Limited, London (GB)

(72) Inventors: Thomas Mesnard, Paris (FR); Remi Munos, London (GB); Alaa Saade, Montreuil (FR); Yunhao Tang, London (GB); Mark Daniel Rowland, London (GB); Theophane Guillaume Weber, London (GB); Wenqi Chen, Cambridge, MA (US)

(21) Appl. No.: 18/424,561

(22) Filed: Jan. 26, 2024

Related U.S. Application Data
(60) Provisional application No. 63/441,366, filed on Jan. 26, 2023.

(51) Int. Cl. G06N 3/092

(52) U.S. Cl. CPC G06N 3/092

(57) ABSTRACT

Methods, systems, and apparatus, including computer programs encoded on computer storage media, for training a neural network used to select actions to be performed by an agent interacting with an environment. Implementations of the system can take into account a level of luck in the environment, and hence whilst learning can account for outcomes that were caused by external factors as well as those dependent on the actions of the agent.

### CROSS-REFERENCE TO RELATED APPLICATION

This application claims priority under 35 U.S.C. 119 to Provisional Application No. 63/441,366, filed Jan. 26, 2023, which is incorporated by reference.

### BACKGROUND

This specification relates to reinforcement learning.

In a reinforcement learning system an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network. Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes reinforcement learning systems that control an agent interacting with an environment. Implementations of the system can take into account a level of luck in the environment, and hence whilst learning can account for outcomes that were caused by external factors as well as those dependent on the actions of the agent.

In one aspect there is described a method performed by one or more computers, and a corresponding system. The method can be used for training an action selection neural network to control an agent to take actions in an environment to perform one or more tasks, in response to observations characterizing states of the environment. The action selection neural network can be used to control the agent during and/or after the training.

Implementations of the method involve identifying a quantile level of a state action value distribution that is closest to a return (i.e. a cumulative measure of reward) for the learned task(s). A training target for training the action selection neural network is determined based on a value for a state of the environment from the state action value distribution at the identified quantile level, which is used a baseline value. The baseline value can, e.g., be determined from a sum or average over possible actions.

Conceptually it has been recognized that the identified quantile level corresponds to a level of luck in the (random) return, i.e. if the identified quantile level is low the random return and the luck level in generating the random return are also low; and vice-versa. Thus the identified quantile level determines a baseline value that can be subtracted from the reward (or return) to compensate for the level of luck, and hence reduce variance in the training target.

In another aspect a luck parameter estimation model is configured to output a luck parameter upon receiving an observation and an action. The luck parameter is predictive of a return value, which is a summation of rewards received during a trajectory of observations following the received observation and action. A baseline model receives an observation, data characterizing an action selection policy of the action selection neural network, and a value for the luck parameter, and outputs a baseline value. The baseline value indicates an expectation of a contribution to the return value independent of further actions of the agent according to the action selection neural network. The parameters of the action selection neural network are updated based on a gradient with respect to the parameters of a function of a luck-adjusted return value for the observation that is based on the return value minus the baseline value.

In another aspect there is provided a method of controlling an agent using the action selection neural network during and/or after training. This can involve, at each of a plurality of time steps, obtaining an observation characterizing a current state of the environment, processing the observation using the action selection neural network to generate an action selection output for controlling the agent to perform the task, and using the action selection output to control the agent.

In a further aspect there is provided an agent including an action selection neural network trained as described herein.

Particular embodiments of the subject matter described in this specification can be implemented so as to realize one or more of the following advantages.

Credit assignment is a longstanding problem in reinforcement learning, and becomes harder as the environments in which reinforcement learning agents operate become more complex. Typically the relationship between actions and rewards is difficult to learn because of its high variance, and generally requires a collection of a large amount of training data. The described techniques enable credit assignment with a reduced variance, improving data efficiency, leading to faster learning and improved final performance, particularly in “difficult” environments. Implementations of the techniques are able to disentangle “luck”, i.e. external randomness that does not depend on the agent's future actions, from skill, which can be characterized by rewards from the actions under a particular luck level. In implementations this is done by forming a training target that accounts for, i.e. depends on, the level of luck. As a loose analogy, whether or not the actions of a football team will be successful in winning a game depends on the opposing team as much as or more than the specific actions taken. Similarly, the described techniques can take account of environmental factors that, separate to the selection of actions for the agent to perform, can influence how well the agent performs a task. Implementations of the described techniques are partly based on the insight that the level of luck can be associated with the quantile level in a distribution of returns.

Thus some implementations of the described techniques are able to learn faster, with reduced computational resources, and can achieve a better level of performance than some previous techniques. They are also robust in high variance environments, e.g. where rewards are small, distant in time from the associated actions, or subject to extrinsic variation.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE FIGURES

FIG. 1 shows a first example reinforcement learning system.

FIG. 2 shows an example implementation of a state action value distribution neural network.

FIG. 3 is a flow diagram of an example process for training an action selection neural network.

FIG. 4 shows a second example reinforcement learning system.

FIG. 5 shows an example implementation of a quantile predictor neural network.

FIG. 6 is a flow diagram of another example process for training an action selection neural network.

FIGS. 7A and 7B illustrate performance of the described techniques.

Like reference numbers and designations in the various drawings indicate like elements.

### DETAILED DESCRIPTION

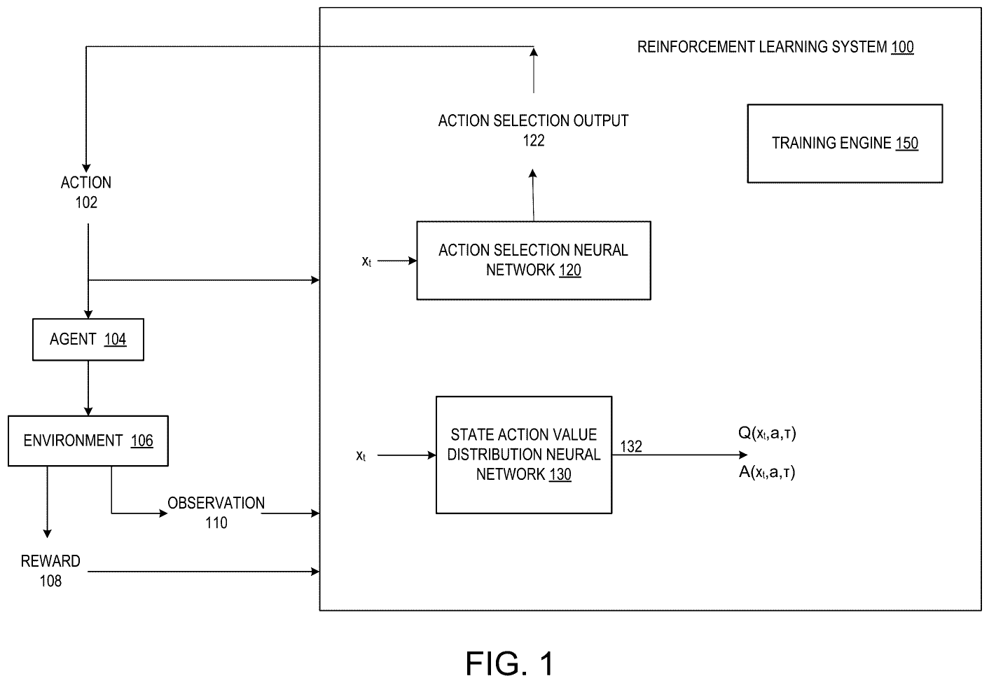

FIG. 1 shows a first example of a reinforcement learning system 100, that may be implemented as one or more computer programs on one or more computers in one or more locations, for training an action selection neural network 120. The action selection neural network 120 is used to control an agent 104 interacting with an environment 106, to perform a task.

Data characterizing a state of the environment 106, e.g. an image of the environment, is referred to herein as an observation 110. An observation can be a multimodal observation, for example a combination of a still or moving image, e.g. from a camera observing the environment 106, and information from one or more other sensors of environment 106. In general the observation 110 of the environment at a current time t can include one or more previous observations and/or actions at one or more earlier times<t. Some examples of agents and environments are described later.

The reinforcement learning system 100 obtains an observation 110 of the environment 106 at each of a succession of time steps; the observation at a time step t is denoted xₜ. The action selection neural network 120 controls the agent 104 by processing the observation 110 at a time step, in accordance with trainable parameters of the action selection neural network, such as weights, to generate an action selection output 122 that is used to select an action 102 at the time step for controlling the agent 104.

Once the reinforcement learning system 100 selects an action 102 to be performed by the agent, the reinforcement learning system can cause the agent 104 to perform the selected action. For example, the system can instruct the agent and the agent can perform the selected action. As another example, the system can directly generate control signals for one or more controllable elements of the agent. As yet another example, the system can transmit data specifying the selected action to a control system of the agent, which controls the agent to perform the action.

The agent performing the selected action results in the environment 106 transitioning into a different state. The agent can also receive a reward 108 at the time step in response to the action. A reward is generally a scalar numerical value; it may be positive, negative, or zero. The reward can characterize progress of the agent towards completing the task, e.g. it can represent completion of a task or progress towards completion of the task as a result of the agent performing the selected action.

There are many ways in which the action selection output 122 can be used to select actions. For example it can define an action directly, e.g. by identifying a speed or torque for a mechanical action; or it can parameterize a distribution from over possible actions, e.g. a Gaussian distribution, according to which the action may be selected e.g. stochastically; or it can define a set of scores for each action of a set of possible actions, according to which an action can be selected, e.g. stochastically. In general an action may be continuous, i.e. defining a continuous action space, or discrete; a continuous action may be discretized. The “action” may comprise multiple individual actions to be performed at a time step e.g. a mixture of continuous and discrete actions. In some implementations the action selection neural network 120 has multiple heads, and the action selection output 122 comprises multiple outputs for selecting multiple actions at a particular time step.

The action selection neural network 120, and in general each of the neural networks described herein, can have any suitable architecture and may include, e.g., one or more feed forward neural network layers, one or more convolutional neural network layers, one or more attention-based neural network layers, or one or more normalization layers, and so forth. In some implementations a neural network as described herein may be distributed over multiple computers.

In FIG. 1 the reinforcement learning system 100 is shown interacting with the environment 106 by using the agent 104 to select actions, and receiving observations 110 and rewards 108. The observations and rewards can be used to train the action selection neural network 120, using a training engine 150, as described later. Also or instead the action selection neural network 120 can be trained using stored training data. As one example, but not essentially, training data may be collected as the agent acts in the environment and stored in a buffer memory (not shown in FIG. 1), sometimes termed a replay buffer, and the stored training data used for training.

In implementations the training data comprises a tuple for each of a plurality of time steps. Each tuple can define an observation characterizing a state of an environment at a time step, an action taken by an agent at the time step, and a reward received in response to the action.

In general the training engine 150 can use online training data, i.e. collected as the agent interacts with the environment, and/or offline training data, i.e. collected previously by the same or a different agent 104. After training the trained action selection neural network 120 can be used to control the agent 104 to perform the task for which it was trained.

The reinforcement learning system 100 includes a state action value distribution neural network 130. In implementations the state action value distribution neural network 130 is configured to process an observation at a time step, xₜ, in accordance with trainable parameters of the state action value distribution neural network, such as weights, to generate a state action value distribution output 132. The state action value distribution output 132 defines a state action value distribution over estimated returns from a state of the environment represented by the observation xₜ and for possible actions, aₜ, of a plurality of possible actions at the time step.

In general a return, Z, can be a cumulative measure of rewards received by the system as the agent interacts with the environment over multiple time steps, e.g. a time-discounted sum of rewards (although in some implementations it may comprise a single reward). A return can be determined, e.g. from a trajectory or time sequence of observation-action-reward tuples.

The Q-value for an action is an estimate of the return that would (on average) result from the agent performing the action in response to the current observation and thereafter selecting future actions performed by the agent in accordance with current values of the action selection neural network parameters.

Implementations of the described techniques determine quantile levels of the Q-function and use these to define a baseline value that represents a part of the (random) return that is generated by a particular level of luck. This can be done by identifying a quantile level (an estimated quantile level) of the state action value distribution that is closest to a return based on the reward in a current tuple.

As some examples, the (estimated) quantile level can be identified by comparison with discrete quantile levels of the state action value distribution output 132 to find the closest; or the (estimated) quantile level closest to the return can be identified by interpolation between discrete quantile levels of the state action value distribution output 132 to either side of, i.e. above and below, the return; or the (estimated) quantile level closest to the return can be identified by prediction using a neural network. This is described in more detail later.

The identified (estimated) quantile level can be considered as a luck parameter predictive of a return value, in particular of a summation of corresponding rewards received during a trajectory of future observations following the received observation and action.

In implementations the state action value distribution defines a state action value for each of a plurality of quantile levels, τ, of the state action value distribution, where τ is a scalar value in the range [0,1] inclusive. The state action value distribution neural network 130 can provide an output for each action of the plurality of actions, or can process an action as well as an observation to generate the state action value distribution for that particular action. Similarly the state action value distribution neural network 130 can provide an output for each of the plurality of quantile levels of the state action value distribution, or it can process a quantile level input to generate an output value for the quantile level. As a further example, the state action value distribution neural network 130 can provide an output that parameterizes the state action value distribution, which in turn defines the quantile levels of the distribution.

In general the quantile levels of a probability distribution, e.g. quartiles, deciles, or percentiles, partition the distribution into quantiles (e.g. ranges of equal likelihood). The quantile function, here Q(x, a, τ), is also sometimes referred to as the inverse cumulative distribution function. For example, the k-th m-quantile is the value where the cumulative distribution function crosses k/m.

Conceptually, sampling the random return can be considered as sampling a quantile level t from a uniform distribution between 0 and 1 (τ˜U(0,1)) and then passing the sampled t into the state action value distribution, Q(x, a, τ). When viewed this way, it can be understood that the quantile level τ can be identified as the level of luck in generating the (random) return, Z.

As indicated in FIG. 1, the state action value distribution output 132 may comprise a Q-value such as, Q(x, a, τ), or it may comprise an advantage value, A(x, a, τ), i.e. a value that defines an advantage estimate for each of the quantile levels of the state action value distribution over a baseline that may be termed a forward baseline. Such an advantage value can be defined by Q(x, a, τ)=V(x)+A(x, a, τ), where V (x) is the forward baseline, which is a value estimate of a state. The value estimate V (x) can represent a value of the environment being in the current state to successfully performing the task, e.g. an estimate of the return for the task resulting from the environment being in a current state characterized by the observation x. This is also described further later.

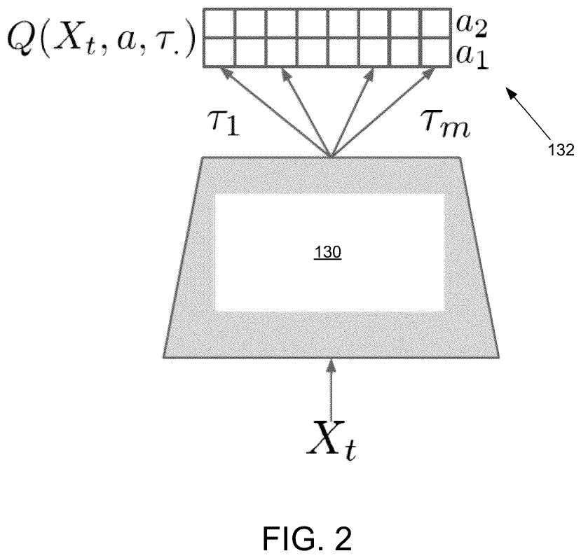

FIG. 2 illustrates one example implementation of the state action value distribution neural network 130.

In the example implementation of FIG. 2 the state action value distribution neural network 130 processes an observation xₜ to generate a state action value distribution output 132 that comprises an output value for each of a plurality of m quantile levels, τ₁ . . . τₘ, of the state action value distribution, and for possible discrete actions a, in the example a₁ and a₂. (As previously noted in other implementations the action a may be continuous and may be an input to the neural network). These define the state action value distribution, Q(x, a, τ), or A(x, a, τ). In an example implementation the state action value distribution neural network 130 of FIG. 2 produces m quantile predictions for

$${τ}_{i} = \frac{2 i - 1}{2 m}$$

with 1≤i≤ m.

A state action value distribution neural network that comprises an output value for each of a plurality of m quantile levels is also referred to herein as a state action value quantile neural network.

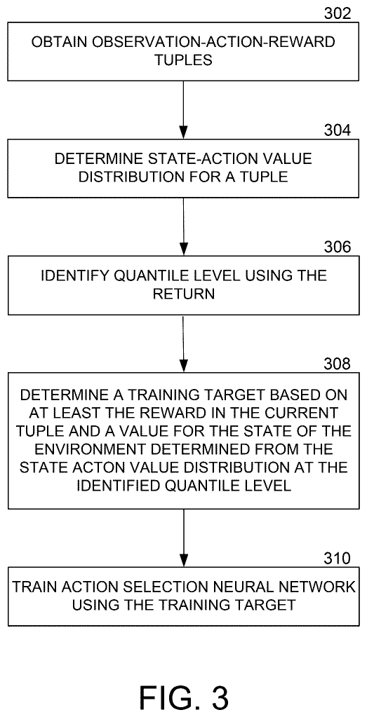

FIG. 3 is a flow diagram of an example process for training an action selection neural network, such as action selection neural network 120, to control an agent to take actions in an environment. The process of FIG. 3 may be implemented by one or more computers in one or more locations. The steps of FIG. 3 need not all be performed in the order shown.

The process obtains training data, comprising an observation-action-reward tuple as described above for each of a plurality of time steps (step 302). For example, the training data may be obtained as the agent acts, or from a buffer memory, or from another source such as another agent. Where a buffer memory is used observation-action-reward tuples may be stored in the buffer memory as the agent 104 is controlled to take actions in the environment 106 to perform the task. When the replay buffer is full the oldest entries may be overwritten, or the buffer memory may be sufficiently large that it does not become full.

The method can perform the steps detailed below for each of the tuples. These steps may be performed synchronously or asynchronously with respect to time steps in which the agent acts in the environment.

The observation in the tuple, xₜ, for a time step, t, and optionally also the action, aₜ, is processed using the state action value distribution neural network 130 to determine the state action value distribution for the observation and for the action in the tuple, Q(xₜ, aₜ, τ) (step 304).

The process then identifies a quantile level (quantile), \hat{τ}, of the state action value distribution that is closest to a return based on the reward in the tuple (step 306). Thus the process identifies the quantile level, \hat{τ}, of the state action value distribution, Q(xₜ, aₜ, τ), for the observation and for the action in the tuple. In some implementations the process identifies quantile level, \hat{τ}, closest to the return as the nearest quantile level, τᵢ, in the state action value distribution output 132. In some implementations the process identifies two quantile levels, τᵢ and τᵢ₊₁, in the state action value distribution output 132, one to either side of (below and above) the return, and linearly interpolates between them to identify the quantile level \hat{τ}.

As described above the quantile level \hat{τ} can be identified as the luck level in the return received by the system: When this quantile level is small luck is bad and the return is small; and vice-versa. Determining the quantile level allows the agent's skill in choosing actions to be disentangled from luck.

As an example, the return, Z, for a time step t (which can more specifically be denoted Zₓ_{ₜ}_{, a}_{ₜ}) can be determined as

$$Z = {Σ}_{s \geq t} {γ}^{s - t} {R}_{s}$$

where Rₛ is ine reward at time step s (at or after t), γ is a discount factor (in the range 0 to 1, typically close to 1), and Rₛ is the reward received at time step s. The return Z can be determined from the tuple at time step t and optionally also from one or more subsequent tuples (i.e. tuples for subsequent time steps), that is, from a trajectory starting at t. To facilitate this the process of FIG. 3 can be performed s time steps in hindsight.

In one example implementation the identified quantile level \hat{τ} can be determined as arg minᵢ(Z−Q(xₜ, aₜ, τᵢ)), i.e. as the nearest quantile level to Z. In another example implementation the identified quantile level \hat{τ} can be determined using linear interpolation, e.g. as \hat{τ}=(1−α)τ_{I}+ατ_{I+1} where I is an index such that Z is in the range [Q(xₜ, aₜ, τ_{I}), Q(xₜ, aₜ, τ_{I+1})] and where

$$α = \frac{Z - Q ( {x}_{t} , {a}_{t} , {τ}_{I} )}{Q ( {x}_{t} , {a}_{t} , {τ}_{I + 1} ) - Q ( {x}_{t} , {a}_{t} , {τ}_{1} )}$$

In the particular case where Z<Q(xₜ, aₜ, τ₁) the quantile level \hat{τ} can be determined as τ₁, and where Z>Q(xₜ, aₜ, τₘ), for m quantile levels (1≤i≤m), the quantile level \hat{τ} can be determined as τₘ.

A further approach, that involves using a quantile predictor neural network to identify a quantile level, \hat{τ}, of the state action value distribution closest to the return, Z, is described later.

The process determines a training target based on a difference between (at least) the reward in the currently processed tuple (e.g. based on an estimated return including the reward), and a value for the state of the environment determined from the state action value distribution at the identified quantile level (step 308).

This can separate a level of luck in the return, from the skill of the system in selecting actions for the agent to perform, as the value for the state of the environment determined from the state action value distribution at the identified quantile level represents a baseline value generated by a particular level of luck.

The process can then train the action selection neural network 120 using the training target (step 310). This can involve training the action selection neural network 120 using a reinforcement learning technique, i.e. using a reinforcement learning objective function that depends on the training target. In implementations, any reinforcement learning objective function can be used.

In general training a neural network as described herein, such as the action selection neural network 120, may comprise backpropagating gradients of an objective function, such as the reinforcement learning objective function, to update the trainable parameters, such as weights, of the neural network. This can be done using any appropriate gradient descent optimization algorithm, e.g. Adam or another optimization algorithm.

As one example, the action selection neural network 120 can be trained using a policy gradient reinforcement learning technique that involves updating the trainable parameters of the action selection neural network based on a product of the training target and gradient of a logarithm of the action selection output 122 (with respect to the parameters of the action selection neural network 120). For example, a gradient of the reinforcement learning objective function can have a policy gradient term, ∇ ln(aₜ|xₜ) (Zₓ_{ₜ}_{, a}_{ₜ}−Q(xₜ, π, \hat{τ}) where Q(xₜ, π, \hat{τ}) is the value for the state of the environment determined from the state action value distribution at the identified quantile level \hat{τ}.

As another example, the action selection neural network 120 can be trained using an actor-critic reinforcement learning technique in which the action selection neural network 120 is the actor, and in which Q(xₜ, π, \hat{τ}) provides a baseline value for the critic. As a further example, the action selection neural network 120 can be trained using a reinforcement learning technique that optimizes the action selection policy indirectly, e.g. MPO (Maximum a Posteriori Policy Optimization, Abdolmaleki et al., 2018) or a variant thereof. Then Q(xₜ, π, \hat{τ}) can be used to provide a baseline value for a critic neural network that is used to improve the action selection policy.

In general the training process, in particular obtaining the training data, can involve controlling the agent 104 to act in the environment 106 using the action selection neural network 120.

Controlling the agent can comprise, at each of a plurality of time steps, obtaining a current observation characterizing a current state of the environment 106, and processing the observation using the action selection neural network 120 to select an action to be performed by the agent 104 at the time step. A subsequent observation can then be obtained, characterizing a subsequent state of the environment 106 at a next time step after the agent performs the selected action, and a reward received. The action selection time steps may be, but do not need to be, synchronous with the training time steps.

In some implementations the value for the state of the environment determined from the state action value distribution at the identified quantile level is obtained, from an average over possible actions, of the state action values in the distribution for the observation and for the identified quantile level. (The possible actions are possible actions under an action selection policy defined by the action selection neural network 120).

As a particular example, this can involve determining the value for the state of the environment from the state action value distribution at the identified quantile level, Q(xₜ, π, \hat{τ}), as Q(xₜ, π, \hat{t})=Σₐπ(a|xₜ)Q(xₜ, a, \hat{t}). Here xₜ is the observation in the tuple, a is a possible action, π(a|xₜ) denotes a probability of taking action a given observation xₜ determined from the action selection neural network 120 (e.g. from the action selection output 122), Q(xₜ, a, \hat{τ}) defines the state action value for the observation xₜ and for action a, and \hat{τ} denotes the identified quantile level. The configuration of the state action value distribution neural network 130 shown in FIG. 2 provides a convenient architecture for determining this action-averaged baseline.

Where the identified quantile level \hat{τ} is determined as

$$arg {min}_{i} ( Z - Q ( {x}_{t} , {a}_{t} , {τ}_{i} ) ) ,$$

i.e. as the quantile level nearest to Z, the state action value for the observation xₜ and for action a, and at the identified quantile level \hat{τ}, Q(xₜ, a, \hat{τ}), can be obtained directly from the state action value distribution output 132. Where the identified quantile level \hat{τ} is determined by interpolation, the value of Q(xₜ, a, \hat{τ}) can be obtained by linear interpolation between Q(xₜ, aₜ, τ₁) and Q(xₜ, aₜ, τ_{I+1}).

The above described process, or another process, can train the state action value distribution neural network 130 using the tuples in the training data and based on a quantile regression loss that defines a quantile regression target for each quantile level.

In implementations the quantile regression target can be based on a difference between the reward in a tuple and the state action value defined by the state action value distribution for the quantile level and for the action in the tuple. In implementations where the quantile regression target is based on the return, the state action value distribution neural network 130 can be trained in hindsight, e.g. using the tuple for a time step and a future trajectory from the time step (defined by the observations, actions, and rewards in one or more tuples for subsequent time steps).

There are several possibilities for the quantile regression loss. As one example a standard quantile regression loss can be employed (e.g. Koenker et al. “Regression quantiles”, Econometrica: Journal of the Econometric Society, pp. 33-50, 1978). As another example, instead of a standard quantile regression loss a quantile Huber loss may be used, as described in Dabney et al., “Distributional Reinforcement Learning with Quantile Regression”, 2017, in particular in the section “Quantile Regression”, more particularly the subsection “Quantile Huber Loss” and equation (10), hereby incorporated by reference.

Merely as an example, for a state action value distribution neural network 130 of the type shown in FIG. 2 that generates m quantile predictions Q(x, a, τᵢ), the ith quantile prediction can be trained using the quantile regression loss τᵢ (Z_{x,a}−Q(x, a, τᵢ)₊+(1−τᵢ) (Z_{x,a}−Q(x, a, τᵢ))₋ where the notation (⋅)₊ and (⋅)₋ means, respectively, the positive and negative part of (⋅). For example, (Z_{x,a}−Q(x, a, τᵢ))₋ is equal to zero when Z_{x,a}−Q(x, a, τᵢ) is positive and is equal to −(Z_{x,a}−Q(x, a, τᵢ)) when Z_{x,a}−Q(x, a, τᵢ) is negative. Thus in this example the quantile regression loss is τᵢ (Z_{x,a}−Q(x, a, τᵢ) when Z_{x,a}−Q(x, a, τᵢ) is positive and the quantile regression loss is (1−τᵢ)(Q(x, a, τᵢ)−Z_{x,a}) when Z_{x,a}−Q(x, a, τᵢ) is negative. Here Z_{x,a} denotes the (random) return at (x, a) under the action selection policy of the action selection neural network 120. In practice the quantile regression loss may be summed over a multiple, e.g. successive, tuples. Training the state action value distribution neural network 130 generally involves backpropagating gradients of the quantile regression loss to update trainable parameters of the neural network using gradient descent-based optimization.

A quantile function, here Q(x, a, τ), increases monotonically as a function of the quantile level τ. Thus in some implementations generating the state action value distribution comprises generating a state action value for a first of the plurality of quantile levels in an ordered sequence of the quantile levels (increasing or decreasing), and then generating state action difference (increment or decrement) values for subsequent quantile levels. Each state action difference value represents a (non-negative) difference between the state action value for the quantile level and the state action value for the previous quantile level in the sequence. This provides an inductive bias that can facilitate learning the quantiles.

For example, in some implementations the state action value distribution neural network 130 is configured to construct each of the quantile predictions, Q (x, a, τᵢ), as a sum of non-negative increments. This can be done by determining Q(x, a, τᵢ) as Q (x, a, τᵢ)=Σⱼ₌₁ⁱ Q(x, a, j) where Q(x, a, j) is parameterized to be non-negative, e.g. by using a softplus activation (log(1+exp(x))) for the output layer of the state action value distribution neural network 130. The first quantile prediction is Q(x, a, 1), and Q(x, a, j) for j≥2 defines the difference between two consecutive quantiles.

As previously mentioned, in some implementations the state action value distribution neural network 130 is configured to generate an advantage value, A(x, a, τ), that defines an advantage of a particular action a over a state value V(x) or “forward baseline”. Then Q(x,a, τ)=V(x)+A(x,a, τ). That is, in some implementations the state action value distribution is generated by summing a value estimate for each of the quantile levels of the state action value distribution (in implementations, the same value estimate for each of the quantile levels of the state action value distribution) and an advantage estimate for each of the quantile levels of the state action value distribution.

In these implementations the state action value distribution generated by the state action value distribution neural network comprises a distribution of advantage values that defines the advantage estimate for each of the plurality of quantile levels of the state action value distribution. A forward baseline neural network, V(x), can be provided to process the observation in a tuple to generate the value estimate for each of the quantile levels of the state action value distribution; here the value estimate is the same for each of the quantile levels of the state action value distribution. In practice the forward baseline neural network can be implemented, e.g., as a separate head of the action selection policy neural network 120. Such a forward baseline neural network, V(x), can be trained using a regression loss, e.g. an L₂ loss, using the return, Z, as a training target. Thus the state action value distribution can define quantile predictions of the return minus the estimated value function.

In broad terms a process as described herein can control the agent 104 to take an action aₜ, selected using the action selection policy neural network 120, and observe the return Zₓ_{ₜ}_{, a}_{ₜ} along the trajectory thereafter. The state action value distribution neural network 130 can be trained using a quantile regression loss, and a quantile level \hat{τ} can be estimated such that Zₓ_{ₜ}_{,a}_{ₜ}≈Q(xₜ, a, \hat{τ}). Then the quantile level \hat{τ} can be used to determine a baseline value for the state of the environment determined from the state action value distribution at the identified quantile level, Q(xₜ, π, \hat{τ}), and this can be used to update the action selection policy of the action selection policy neural network 120, e.g. with a policy gradient-based parameter update.

As described above the identified quantile level, \hat{τ}, is estimated by comparing the output of the state action value distribution neural network 130 with the observed return. However in some implementations the identified quantile level, \hat{τ}, is estimated using a quantile predictor neural network.

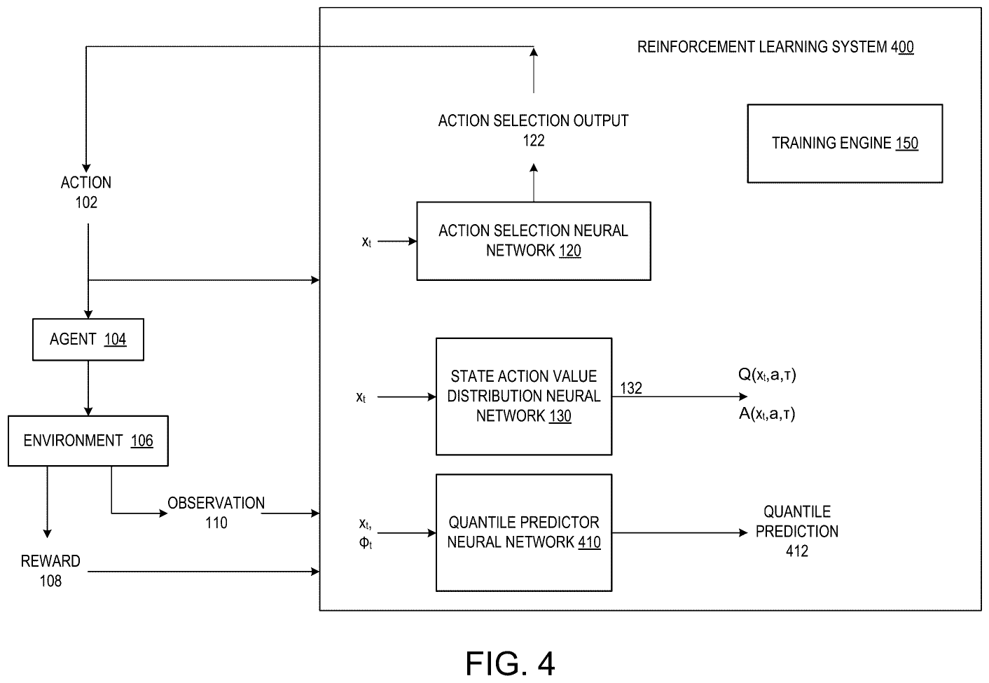

FIG. 4 shows a second example of a reinforcement learning system 400, that may be implemented as one or more computer programs on one or more computers in one or more locations, for training the action selection neural network 120.

The example reinforcement learning system 400 of FIG. 4 includes a quantile predictor neural network 410 that is configured to process the observation, xₜ, in a tuple for a current time step and data, ϕₜ, from one or more tuples for one or more time steps subsequent to t, e.g. from one or more of the observations, actions and rewards in these tuples. The quantile predictor neural network 410 generates a quantile prediction 412 that predicts the identified quantile level, \hat{τ}, of the return, Zₓ_{ₜ}_{,a}_{ₜ}, for the current time step.

Then identifying the quantile level, \hat{τ}, of the state action value distribution that is closest to a return based on the reward in the tuple can include processing the observation in the tuple and data from one or more subsequent tuples using the quantile predictor neural network 410, to generate the quantile prediction 412, and determining (or correcting) the identified quantile level using the quantile prediction.

In some implementations the quantile prediction 412 comprises a probability P(τᵢ|x, a, ϕ) for each quantile level, τᵢ, for a given observation, x, action, a, and other subsequent data, ϕ; in others the quantile predictor neural network 410 can process a quantile level input to determine a probability for that quantile level. The quantile predictor neural network 410 can provide an output for each action of the plurality of actions; or it can process an action as well as an observation to generate the quantile prediction for that action.

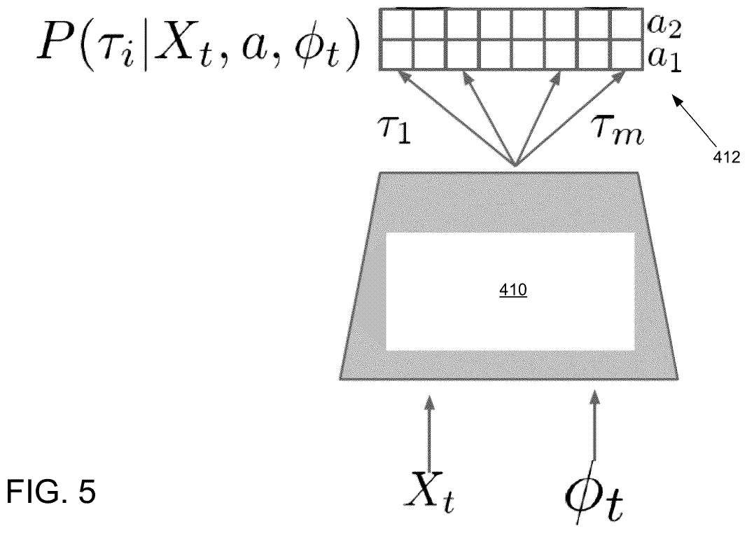

FIG. 5 illustrates one example implementation of the quantile predictor neural network 410. In the example implementation of FIG. 5 the quantile predictor neural network 410 processes the observation xₜ for a time step t and data from one or more tuples after time step t, ϕₜ, to generate the quantile prediction 412, P(τᵢ|xₜ, a, ϕₜ), here a probability for each quantile level, τᵢ (1≤i≤m), and for each possible action, a.

As one example, identifying the quantile level for a time step t, \hat{τ}ₜ, using the quantile prediction 412 can involve identifying a quantile level, τ, with a highest predicted probability, e.g. according to

$${\hat{τ}}_{t} = arg {max}_{τ i} P ( {τ}_{i} \vert {x}_{t} , {a}_{t} , {ϕ}_{t} )$$

where xₜ is the observation at time step t, aₜ is the action aₜ time step t, ϕₜ denotes data from one or more tuples after time step t, and P(τᵢ|xₜ, aₜ, ϕₜ) is the probability of quantile level τᵢ obtained from the quantile prediction 412.

As another example identifying the quantile level for a time step t, \hat{τ}ₜ, using the quantile prediction 412 can involve determining an average quantile level from the quantile prediction 412, e.g. according to \hat{τ}ₜ=Σᵢ₌₁^{m}τᵢ P(τᵢ|xₜ, aₜ, ϕₜ).

The data from one or more tuples after time step t, ϕₜ, can be obtained by processing one or more of the observations, actions and rewards in these tuples, to generate a feature vector output ϕₜ that represents a summary of this (hindsight) information, e.g. using a neural network. This can be done in hindsight, e.g. s time steps in hindsight for a trajectory defined by s tuples (xₛ, aₛ, Rₛ)_{s≥t}. As one particular example, the feature vector ϕₜ may be generated by processing the data from the tuples using a backward RNN (recurrent neural network), i.e. an RNN that processes data items in a direction that is backwards in time.

In implementations, predicting the quantile level using a quantile predictor neural network 410 as described above allows the subsequent data, ϕ, to be used to determine the “luck level”. As example, the environmental conditions may influence the performance of a robot on a task, and by using observations of these conditions it may be possible to identify the level of luck in a task more directly than by inferring this from the return. For example, the quantile predictor neural network 410 could learn to predict the quantile level \hat{τ} (“luck level”) regardless of the particular actions taken. A further advantage is that a mapping from the subsequent data, ϕ, to a prediction of the quantile level \hat{τ} may generalize better than a prediction of the quantile level estimated from just the return.

The quantile predictor neural network 410 can be trained jointly with the state action value distribution neural network 130 (using a shared loss), but it can be useful to train the quantile predictor neural network 410 separately, i.e. using separate losses to train these two neural networks. In particular training the quantile predictor neural network 410 separately allows the quantile level prediction to be learned independently of the action aₜ given xₜ, potentially capturing more information from the subsequent data, ϕ. That is, after the quantile predictor neural network 410 has been trained the predicted quantile level, \hat{τ}, can be independent of the action aₜ selected in response to the observation xₜ.

For example, the quantile predictor neural network 410 can be trained to predict the quantile level \hat{τ} estimated by the state action value distribution neural network 130, e.g.

$$arg {min}_{i} ( Z - Q ( {x}_{t} , {a}_{t} , {τ}_{i} ) )$$

$$or$$

$$\hat{τ} = ( 1 - α ) {τ}_{I} + α {τ}_{I + 1}$$

as described above. This can be done, e.g., using a cross-entropy loss. A neural network generating the feature vector Pt, e.g. a backwards RNN, can be trained using the same loss, by backpropagating gradients from the quantile predictor neural network 410 into this neural network.

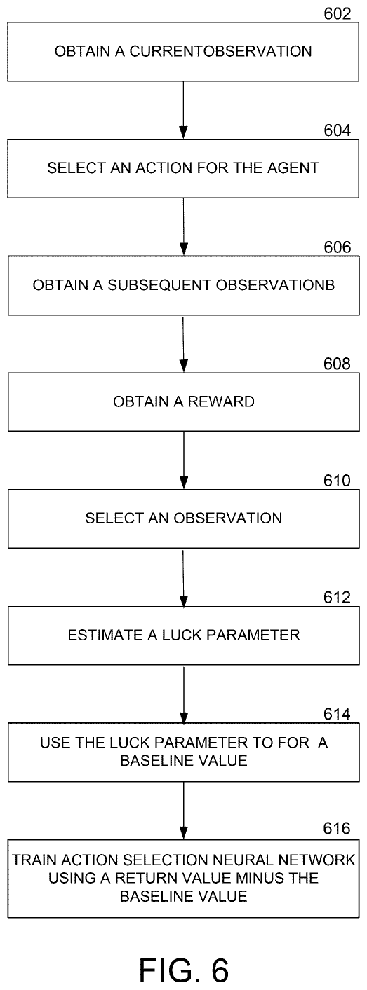

FIG. 6 is a flow diagram of another example process for training an action selection neural network such as action selection neural network 120, of an action selection system, to select actions of an agent 104 interacting with an environment 106 to perform one or more tasks. The process of FIG. 6 may be implemented by one or more computers in one or more locations. The steps of FIG. 6 need not all be performed in the order shown.

In implementations each task has at least one respective reward associated with performance of the task. The agent 104 is controlled by a process comprising, at each of a plurality of time steps, obtaining a current observation characterizing a current state of the environment (step 602), processing the current observation using the action selection neural network to select an action to be performed by the agent at the time step (step 604), obtaining a subsequent observation characterizing a subsequent state of the environment at a next time step after the agent performs the selected action (step 606), and obtaining a reward based on the subsequent observation (step 608).

The example process of FIG. 6 uses a training database of training data which comprises a plurality of trajectories, each trajectory comprising a sequence of observations characterizing consecutive states of the environment at corresponding time steps during a performance of the task, and for each observation of the state of the environment a corresponding action performed by the agent when the environment was in the corresponding state, a corresponding successive observation of a corresponding successive state of the environment, and a corresponding reward based on the corresponding successive observation.

The process includes, in each of a plurality of steps: selecting an observation from the training database (step 610), using a luck parameter estimation model to form an estimate of a luck parameter (step 612) and, based on the estimate of the luck parameter, using a baseline model to form a baseline value for the observation (step 614). The process updates trainable parameters of the action selection neural network based on a gradient with respect to the parameters of a function of a luck-adjusted return value for the observation. In implementations the luck-adjusted return value is based on a return value for a sequence of observations in the training database following the selected observation, minus the baseline value (step 616).

In implementations of the above described method the luck parameter estimation model is configured, upon receiving an observation and an action, to output a luck parameter predictive of a return value which is a summation of corresponding rewards received during a trajectory of future observations following the received observation and action. In implementations the luck parameter defines a quantile (level), τ, of a distribution of the return value, Z. The luck parameter estimation model can be provided by the above described quantile predictor neural network 410.

In implementations of the above described method the baseline model is configured, upon inputting an observation, data characterizing an action selection policy of the action selection neural network, and a value for the luck parameter, to output a baseline value indicative of an expectation of a contribution to the return value, which contribution is a summation of corresponding rewards received during a trajectory of future observations following the input observation and action and independent of further actions of the agent according to the action selection neural network. The baseline model can be provided by the above described state action value distribution neural network 130 in combination with a subsystem to determine the value for the state of the environment from the state action value distribution at the identified quantile level, e.g. as Q(xₜ, π, \hat{τ})=Σₐ π(α|xₜ) Q(xₜ, a, \hat{τ}).

As described above the value for the state of the environment is determined from the state action value distribution at the identified quantile level. However in some alternative implementations the value for the state of the environment is instead determined from a value distribution for the observation over estimated returns from the state of the environment, at the identified quantile level.

These implementations can involve maintaining a value distribution neural network V(x, τ). The value distribution neural network can be configured to process an observation at a time step to generate a value distribution over estimated returns from a state of the environment represented by the observation, e.g. as a value for each of a plurality of quantile levels of the value distribution. The observation in a tuple can be processed using the value distribution neural network to determine the value distribution for the observation. The value distribution can define an average of state action values over possible actions (under an action selection policy defined by an action selection neural network).

Some implementations can maintain both the described state action value distribution neural network 130 and a value distribution neural network. Then the value distribution neural network and the state action value distribution neural network can share a common neural network torso, with separate neural network heads to generate V(x, τ) and Q(xₜ, a, τ).

The value distribution neural network can be trained using a quantile regression loss, e.g. as described above, with the value for the state of the environment determined from the state action value distribution at the identified quantile level (Q(xₜ, π, τ)) as the target.

As previously mentioned, the described techniques are not restricted to any particular neural network architecture. However merely as an illustration, in one example architecture visual observations are preprocessed by a convolutional neural network (CNN) the output of which is flattened and provided to a linear layer. The output of this linear layer is concatenated with the reward at the previous time step and provided to a forward LSTM that maintains a system state. Where implemented, the hindsight feature vector ϕₜ is computed by a backward LSTM that has as an input the output of the forward LSTM and the reward at the previous time step. The action selection neural network 120 comprises an MLP (Multi-Layer Perceptron) with an input from the output of the forward LSTM, and a linear layer to decode the action selection output 122; in implementations the “forward baseline” is also linearly decoded from the output of this MLP. The state action value distribution neural network 130 comprises another MLP with the output of the forward LSTM as input. The quantile predictor neural network 410 comprises a further MLP with a concatenation of the output of the forward LSTM and the hindsight feature vector as input. In some example implementations m=5 or m=10.

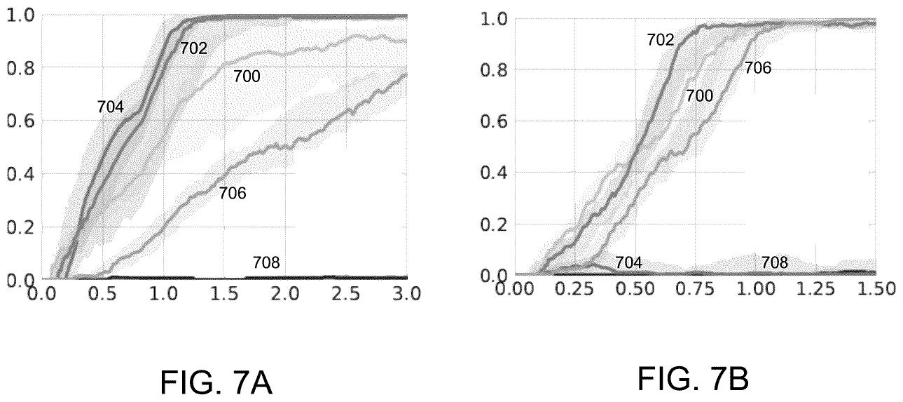

FIGS. 7A and 7B relate to tasks in which the agent 104 has to collect an item, for which it receives a reward, and is then subject to a distraction phase in which other rewards are received, before it uses the item to perform a final task for which it receives a further reward. In FIG. 7A the agent performs distractor tasks for which it receives rewards; in FIG. 7B the agent receives a random reward at each time step during the distraction phase. Each of FIG. 7A and FIG. 7B shows a graph with probability of success in the final task on the y-axis against number of training steps (×10⁸) on the x-axis. Curve 700 shows the performance of a system of the type shown in FIG. 1; curve 702 shows the performance of a system of the type shown in FIG. 4; curve 704 shows the performance of a system that uses Counterfactual Credit Assignment as described in Mesnard et al. 2020, arXiv: 2011.09464; curve 706 shows the performance of a system that uses distributional reinforcement learning, in particular a policy gradient-based technique with a distributional critic, using the mean estimated by the critic as a baseline; and curve 708 (invisible as it lies along the x-axis) shows the performance of a system that uses policy gradient-based reinforcement learning with a baseline but without a distributional critic. It can be seen that implementations of the described techniques can outperform the other approaches.

The techniques described herein are widely applicable but for illustrative purposes, a small number of example implementations are described below. Whilst some implementations are described with reference to a single agent and a single task the described techniques are also useful in multi-task and/or multi-agent environments.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the mechanical agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, or chemical synthesis steps, e.g. by controlling synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry e.g. component density, operating speed, power consumption, material usage, a cooling requirement, level of electromagnetic emissions, and so forth. The observations may be e.g. observations of component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, the reinforcement learning system may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system. The reinforcement learning system chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. During an on-policy training phase and/or another phase in which the history database is being generated, the experience tuples may record the action which the user actually performed based on the instruction, rather than the one which the reinforcement learning system instructed the user to perform. The reward value of each experience tuple may be generated, for example, by comparing the action the user took with a corpus of data showing a human expert performing the task, e.g. using techniques known from imitation learning. Note that if the user performs actions incorrectly (i.e. performs a different action from the one the reinforcement learning system instructs the user to perform) this adds one more source of noise to sources of noise which may already exist in the environment. During the training process the reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

As an illustrative example a user may be interacting with a digital assistant and ask for help performing an overall task consisting of multiple steps, e.g. cooking a pasta dish. While the user performs the task, the digital assistant receives audio and/or video inputs representative of the user's progress on the task, e.g. images or video or sound clips of the user cooking. The digital assistant uses a system as described above, in particular by providing it with the captured audio and/or video and a question that asks whether the user has completed a particular step, e.g. ‘Has the user finished chopping the peppers?’, to determine whether the user has successfully completed the step. If the answer confirms that the use has successfully completed the step then the digital assistant progresses to telling the user to perform the next step or, if at the end of the task, or if the overall task is a single-step task, then the digital assistant may indicate this to the user. The digital assistant may then stop receiving or processing audio and/or video inputs to ensure privacy and/or reduce power use.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as LaMDA, Sparrow, or Chinchilla. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In the implementations above, the environment may not include a human being or animal. In other implementations, however, it may comprise a human being or animal. For example, the agent may be an autonomous vehicle in an environment which is a location (e.g. a geographical location) where there are human beings (e.g. pedestrians or drivers/passengers of other vehicles) and/or animals, and the autonomous vehicle itself may optionally contain human beings. The environment may also be at least one room (e.g. in a habitation) containing one or more people. The human being or animal may be an element of the environment which is involved in the task, e.g. modified by the task (indeed, the environment may substantially consist of the human being or animal). For example the environment may be a medical or veterinary environment containing at least one human or animal subject, and the task may relate to performing a medical (e.g. surgical) procedure on the subject. In a further implementation, the environment may comprise a human user who interacts with an agent which is in the form of an item of user equipment, e.g. a digital assistant. The item of user equipment provides a user interface between the user and a computer system (the same computer system(s) which implement the reinforcement learning system, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. In this way, a personalized system may be provided for the user to control the computer system, again tailored to the aptitudes and current knowledge of the user.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The main elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can also be used to provide interaction with a user; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method, implemented by one or more computers, of training an action selection neural network to control an agent to take actions in an environment, in response to observations characterizing states of the environment, to perform one or more tasks, the method comprising:
maintaining a state action value distribution neural network, wherein the state action value distribution neural network is configured to process an observation at a time step to generate a state action value distribution over estimated returns from a state of the environment represented by the observation and for possible actions of a plurality of possible actions at the time step, wherein the state action value distribution defines a state action value for each of a plurality of quantile levels of the state action value distribution; and
obtaining training data comprising, for each of a plurality of time steps, a tuple defining: an observation characterizing a state of an environment at a time step, an action taken by an agent at the time step, a reward received in response to the action; and, for each of a plurality of the tuples:
processing the observation in the tuple representing a state of the environment, using the state action value distribution neural network, to determine the state action value distribution for the observation and for the action in the tuple;
identifying a quantile level of the state action value distribution that is closest to a return based on the reward in the tuple;
determining a training target based on at least a difference between the reward in the tuple and a value for the state of the environment determined i) from the state action value distribution at the identified quantile level, or ii) from a value distribution for the observation over estimated returns from the state of the environment, at the identified quantile level;
training the action selection neural network using the training target, wherein the action selection neural network is configured to process an observation to generate an action selection output for controlling the agent to perform the task.

2. The method of claim 1, wherein the value for the state of the environment is determined from an average over the possible actions of state action values of the state action value distribution for the observation, at the identified quantile level.

3. The method of claim 2, comprising determining the value for the state of the environment from the state action value distribution at the identified quantile level, Q(xₜ, π, \hat{τ}), as Q(xₜ, π, \hat{τ})=Σₐ π(α|xₜ) Q(xₜ, a, \hat{τ}) where xₜ is the observation in the tuple, a is a possible action, π(a|xₜ) denotes a probability of taking action a given observation xₜ determined from an action selection output of the action selection neural network, Q(xₜ, a, \hat{τ}) defines the state action value for the observation xₜ and for action a, and \hat{τ} denotes the identified quantile level.

4. The method of claim 1, wherein identifying the quantile level of the state action value distribution that is closest to the return based on the reward in the tuple, further comprises determining an estimate of the quantile level, \hat{τ}, for which Z=Q(xₜ, aₜ, \hat{τ}) where Q(xₜ, aₜ, τ) defines the state action value for the observation xₜ in the tuple and for the action aₜ in the tuple, and where Z denotes the return for the observation xₜ in the tuple and for the action a_{t.}

5. The method of claim 4, wherein determining an estimate of the quantile level, \hat{τ}, for which Z=Q(xₜ, aₜ, \hat{τ}) comprises determining \hat{τ} from a linear interpolation between quantile levels of the state action value distribution to either side of the return based on the reward in the tuple.

6. The method of claim 1, wherein the return is based on a discounted sum of the reward in the tuple and the rewards in a succession of subsequent tuples.

7. The method of claim 1, wherein the state action value distribution neural network comprises a state action value quantile neural network that is configured to generate an output value for each of the plurality of quantile levels of the state action value distribution.

8. The method of claim 1, further comprising:
training the state action value distribution neural network using the tuples in the training data and based on a quantile regression loss that defines a quantile regression target for each quantile level based on a difference between the reward in the tuple and the state action value defined by the state action value distribution for the quantile level and for the action in the tuple.

9. The method of claim 1, wherein generating the state action value distribution comprises:
summing a value estimate for each of the quantile levels of the state action value distribution and an advantage estimate for each of the quantile levels of the state action value distribution.

10. The method of claim 9, wherein the state action value distribution generated by the state action value distribution neural network comprises a distribution of advantage values that defines the advantage estimate for each of the plurality of quantile levels of the state action value distribution.

11. The method of claim 1, wherein generating the state action value distribution comprises:
generating a state action value for a first of the plurality of quantile levels in an ordered sequence of the quantile levels, and
generating state action difference values for subsequent ones of the plurality of quantile levels.

12. The method of claim 1, wherein obtaining training data comprises:
maintaining a buffer memory storing the tuples; and
adding tuples into the buffer memory based on observations of the environment, selected actions, and rewards obtained as the agent is controlled to take actions in the environment to perform the task.

13. The method of claim 1, further comprising training the state action value distribution neural network in hindsight, wherein the training in hindsight comprises:
training the state action value distribution neural network using the tuple for a time step and a future trajectory from the time step, wherein the future trajectory from the time step is defined by the observations, actions, and rewards in and one or more tuples for time steps subsequent to the time step.

14. The method of claim 1, further comprising:
maintaining a quantile predictor neural network configured to process the observation in a tuple for a current time step and data in one or more tuples for subsequent time steps to generate a quantile prediction that predicts the identified quantile for the current time step; and
wherein identifying a quantile level of the state action value distribution that is closest to a return based on the reward in the tuple comprises:
processing the observation in the tuple and data from one or more subsequent tuples using the quantile predictor neural network, to generate the quantile prediction; and
determining the identified quantile level using the quantile prediction.

15. The method of claim 1, comprising:
training the action selection neural network using a policy gradient reinforcement learning technique by updating parameters of the action selection neural network based on a product of the training target and gradient of a logarithm of the action selection output.

16. One or more computer-readable storage media storing instructions that when executed by one or more computers cause the one or more computers to perform operations for training an action selection neural network to control an agent to take actions in an environment, in response to observations characterizing states of the environment, to perform one or more tasks, the operations comprising:
maintaining a state action value distribution neural network, wherein the state action value distribution neural network is configured to process an observation at a time step to generate a state action value distribution over estimated returns from a state of the environment represented by the observation and for possible actions of a plurality of possible actions at the time step, wherein the state action value distribution defines a state action value for each of a plurality of quantile levels of the state action value distribution; and
obtaining training data comprising, for each of a plurality of time steps, a tuple defining: an observation characterizing a state of an environment at a time step, an action taken by an agent at the time step, a reward received in response to the action; and, for each of a plurality of the tuples:
processing the observation in the tuple representing a state of the environment, using the state action value distribution neural network, to determine the state action value distribution for the observation and for the action in the tuple;
identifying a quantile level of the state action value distribution that is closest to a return based on the reward in the tuple;
determining a training target based on at least a difference between the reward in the tuple and a value for the state of the environment determined i) from the state action value distribution at the identified quantile level, or ii) from a value distribution for the observation over estimated returns from the state of the environment, at the identified quantile level;
training the action selection neural network using the training target, wherein the action selection neural network is configured to process an observation to generate an action selection output for controlling the agent to perform the task.

17. A system comprising one or more computers and one or more storage devices storing instructions that when executed by one or more computers cause the one or more computers to perform operations for training an action selection neural network to control an agent to take actions in an environment, in response to observations characterizing states of the environment, to perform one or more tasks, the operations comprising:
maintaining a state action value distribution neural network, wherein the state action value distribution neural network is configured to process an observation at a time step to generate a state action value distribution over estimated returns from a state of the environment represented by the observation and for possible actions of a plurality of possible actions at the time step, wherein the state action value distribution defines a state action value for each of a plurality of quantile levels of the state action value distribution; and
obtaining training data comprising, for each of a plurality of time steps, a tuple defining: an observation characterizing a state of an environment at a time step, an action taken by an agent at the time step, a reward received in response to the action; and, for each of a plurality of the tuples:
processing the observation in the tuple representing a state of the environment, using the state action value distribution neural network, to determine the state action value distribution for the observation and for the action in the tuple;
identifying a quantile level of the state action value distribution that is closest to a return based on the reward in the tuple;
determining a training target based on at least a difference between the reward in the tuple and a value for the state of the environment determined i) from the state action value distribution at the identified quantile level, or ii) from a value distribution for the observation over estimated returns from the state of the environment, at the identified quantile level;
training the action selection neural network using the training target, wherein the action selection neural network is configured to process an observation to generate an action selection output for controlling the agent to perform the task.

18. The system of claim 17, wherein the value for the state of the environment is determined from an average over the possible actions of state action values of the state action value distribution for the observation, at the identified quantile level.

19. The system of claim 18, comprising determining the value for the state of the environment from the state action value distribution at the identified quantile level, Q(xₜ, π, \hat{τ}), as Q(xₜ, π, \hat{τ})=Σₐ η(a|xₜ)Q(xₜ, a, \hat{τ}) where xₜ is the observation in the tuple, a is a possible action, π(a|xₜ) denotes a probability of taking action a given observation xₜ determined from an action selection output of the action selection neural network, Q(xₜ, a, \hat{τ}) defines the state action value for the observation xₜ and for action a, and \hat{τ} denotes the identified quantile level.

20. The system of claim 17, wherein identifying the quantile level of the state action value distribution that is closest to the return based on the reward in the tuple, further comprises determining an estimate of the quantile level, \hat{τ}, for which Z=Q(xₜ, aₜ, \hat{τ}) where Q(xₜ, aₜ, \hat{τ}) defines the state action value for the observation xₜ in the tuple and for the action aₜ in the tuple, and where Z denotes the return for the observation xₜ in the tuple and for the action aₜ.
